(19) United States
(12) Patent Application Publication
(10) Pub. No.: US 2014/0207421 A1
(43) Pub. Date: Jul. 24, 2014

(54) DRAWING DATA GENERATION METHOD, PROCESSING APPARATUS, STORAGE MEDIUM, DRAWING APPARATUS, AND ARTICLE MANUFACTURING METHOD

(71) Applicant: CANON KABUSHIKI KAISHA, Tokyo (JP)

(72) Inventor: Yusuke Sugiyama, Utsunomiya-shi (JP)

(73) Assignee: CANON KABUSHIKI KAISHA, Tokyo (JP)

(21) Appl. No.: 14/160,688

(22) Filed: Jan. 22, 2014

(30) Foreign Application Priority Data
Jan. 22, 2013 (JP) 2013-009616

(51) Int. Cl. G06F 17/50

(52) U.S. Cl. CPC G06F 17/50
USPC 703/1

(57) ABSTRACT

A generation method of generating drawing data for performing drawing on a substrate by a drawing apparatus based on pattern data associated with a two-dimensional grid include: dividing the two-dimensional grid into a plurality of rectangular regions based on an angle by which the pattern data is rotated; and obtaining a translation amount of partial data of the pattern data with respect to each of the plurality of rectangular regions based on the angle.

### BACKGROUND OF THE INVENTION

1. Field of the Invention

The present invention relates to a drawing data generation method, processing apparatus, storage medium, drawing apparatus, and article manufacturing method.

2. Description of the Related Art

Recently, a charged particle beam drawing apparatus has been used as an apparatus which draws the pattern of a semiconductor integrated circuit. When drawing a pattern by using the charged particle beam drawing apparatus, design pattern data created by CAD or the like needs to be converted into a data format which can be input to the charged particle beam drawing apparatus. In general, design pattern data generated by CAD or the like is vector format data (vector data) formed from end point data of a figure or the like, and drawing data input to the apparatus is binary or multilevel bitmap format data (raster data). A series of intermediate processing data until drawing data is generated from design pattern data will be called “pattern data”.

Errors originated from a drawing apparatus and drawing step include a mechanical position error, optical aberration, and an overlay error with respect to an underlayer. To correct these errors and draw a desired pattern, design pattern data and drawing data need to undergo geometrical conversion. This geometrical conversion is also called correction processing. Examples of the geometrical conversion are magnification, translation, and rotation operations, and sometimes include higher-order operations or non-linear operations. These correction processes are performed in the course of data conversion. Which of vector data and raster data is used as data to be processed has a tradeoff with respect to necessary performance. Although correction processing can be performed for vector data in terms of calculation accuracy, raster data is more advantageous in terms of the complexity of the processing circuit. Note that the installation cost and data amount depend on a target pattern and the contents of correction processing, and this determination cannot be made unconditionally.

In a drawing method disclosed in Japanese Patent Laid-Open No. 2003-297732, a position shift between a shape to be drawn with a charged particle beam and the shape of a target pattern is approximated by a high-order polynomial, and data is translated based on the approximation result. As for the connecting portion of the pattern, a margin is set at the boundary of data to suppress a connection shift. In a drawing method disclosed in Japanese Patent Laid-Open No. 2006-086182, the center positions of a shape to be drawn with a charged particle beam and the shape of a desired pattern are aligned by translating drawing data in alignment between these shapes, and a rotation shift is canceled by a biaxial deflector. Even in this case, as for the connecting portion of the pattern, a margin is set at the boundary of data to suppress a connection shift.

As the integration degrees and scales of semiconductor integrated circuits increase, the data amount of design pattern data is increasing and correction processing is becoming more accurate (that is, the correction amount is greatly decreasing). The method in Japanese Patent Laid-Open No. 2003-297732 implements high-accuracy correction processing, but needs to use approximation by a high-order polynomial for calculation of a correction amount. Thus, correction processing in Japanese Patent Laid-Open No. 2003-297732 requires an approximation calculation circuit for a trigonometric function or a large-scale lookup table. An operation circuit for the correction processing becomes expensive. In addition, the correction processing in Japanese Patent Laid-Open No. 2003-297732 is only correction processing by translation and cannot correct a rotation error. The drawing method in Japanese Patent Laid-Open No. 2006-086182 can correct a rotation error. However, calculation of a correction amount requires an expensive operation circuit, and a biaxial deflector is required separately to cancel a rotation shift.

In the related art, an expensive operation circuit is necessary, and another mechanism sometimes needs to be arranged in addition to data. Further, along with an increase in data amount to be processed, operation circuits for data conversion and correction processing become sophisticated and upsized. As a result, the throughput drops and the apparatus cost rises. In other words, the processing efficiency of correction processing needs to be improved without separately adding a mechanism.

Next, it is confirmed whether a rotation operation requiring an expensive operation circuit can be reduced in order to improve the processing efficiency. FIGS. 1A to 1D show the course of correction processing for pattern data using a simple figure. Each of plots in FIGS. 1A to 1D represents a pattern region stippled at a satisfactorily fine coordinate resolution for convenience. FIG. 1A shows design pattern data before rotational correction in which a single rectangular pattern exists. FIG. 1B shows the result of adding a very small rotational correction amount to this pattern data. FIG. 1C shows the result of discretizing the result in FIG. 1B further in the unit of drawing data because drawing data is raster data, as described above. As is apparent from FIGS. 1B and 1C, the drawing data does not reflect the result of the rotation operation. Note that FIG. 1D shows pattern data obtained by performing operation processing according to the present invention (to be described later).

In FIGS. 2A to 2D, the same correction processing as that in FIGS. 1A to 1D is performed for a large figure. The same comparison as that described above is performed in FIGS. 2B and 2C. This reveals that the result of the rotation operation is reflected in drawing data though there is an error. As is apparent from FIGS. 1A to 1D and 2A to 2D, rotational correction is necessary even for a very small correction amount. However, the operation result is reflected in a large figure. When there coexist many fine figures, like a circuit pattern, the operation may come to nothing as a consequence. Note that FIG. 2D shows pattern data obtained by performing operation processing according to the present invention (to be described later).

### SUMMARY OF THE INVENTION

The present invention provides, for example, a technique advantageous in efficiency with which generation of drawing data, accompanied by processing concerning rotation of pattern data, is executed.

The present invention in its one aspect provides a generation method of generating drawing data for performing drawing on a substrate by a drawing apparatus based on pattern data associated with a two-dimensional grid, the method comprising steps of: dividing the two-dimensional grid into a plurality of rectangular regions based on an angle by which the pattern data is rotated; and obtaining a translation amount of partial data of the pattern data with respect to each of the plurality of rectangular regions based on the angle.

Further features of the present invention will become apparent from the following description of exemplary embodiments with reference to the attached drawings.

### BRIEF DESCRIPTION OF THE DRAWINGS

FIGS. 1A to 1D are views showing the result of correction processing for pattern data using a small, simple figure;

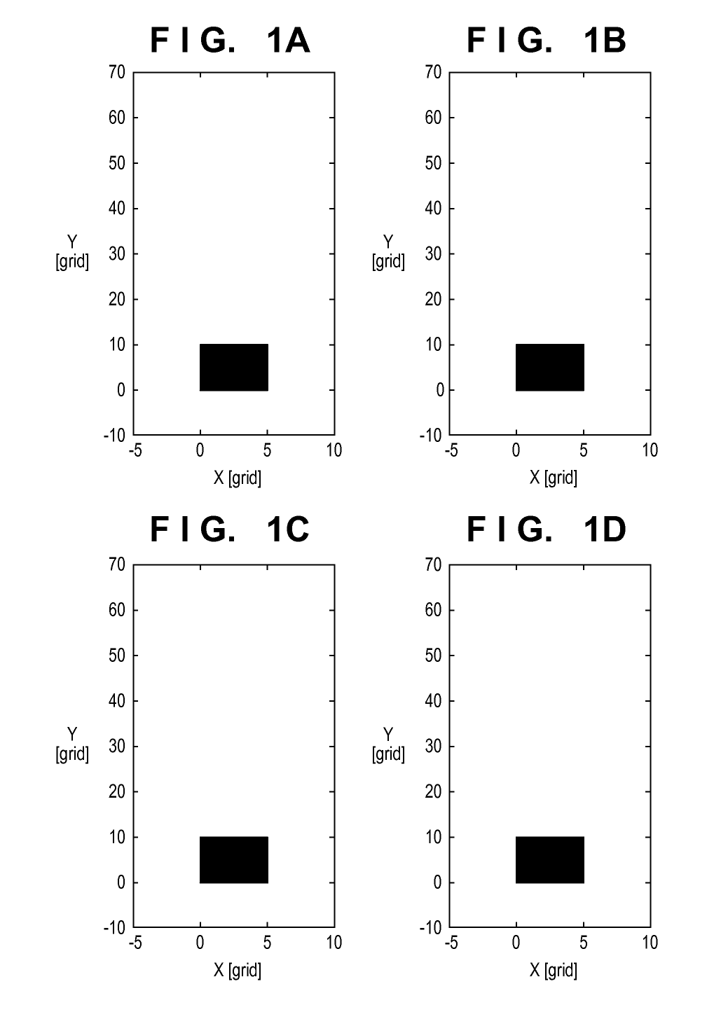

FIGS. 2A to 2D are views showing the result of correction processing for pattern data using a large, simple figure;

FIGS. 3A and 3B are block diagrams showing processing units according to the related art and the present invention;

FIG. 4 is a flowchart for replacing a rotation operation in the processing unit according to the present invention;

FIGS. 5A to 5F are schematic views showing the course of processes in correction processing according to the first embodiment;

FIGS. 6A to 6D are schematic views showing the course of processes in correction processing according to the second embodiment; and

FIGS. 7A to 7C are schematic views showing the course of processes in correction processing according to the third embodiment.

### DESCRIPTION OF THE EMBODIMENTS

Details of a generation method of generating drawing data for performing drawing on a substrate by a drawing apparatus based on pattern data represented by dots on two-dimensional grids according to the present invention will be described with reference to illustrated embodiments. In the present invention, when drawing is performed using the drawing apparatus in accordance with pattern data, rotation, shift (translation), and a change of the magnification of a pattern occur.

### First Embodiment

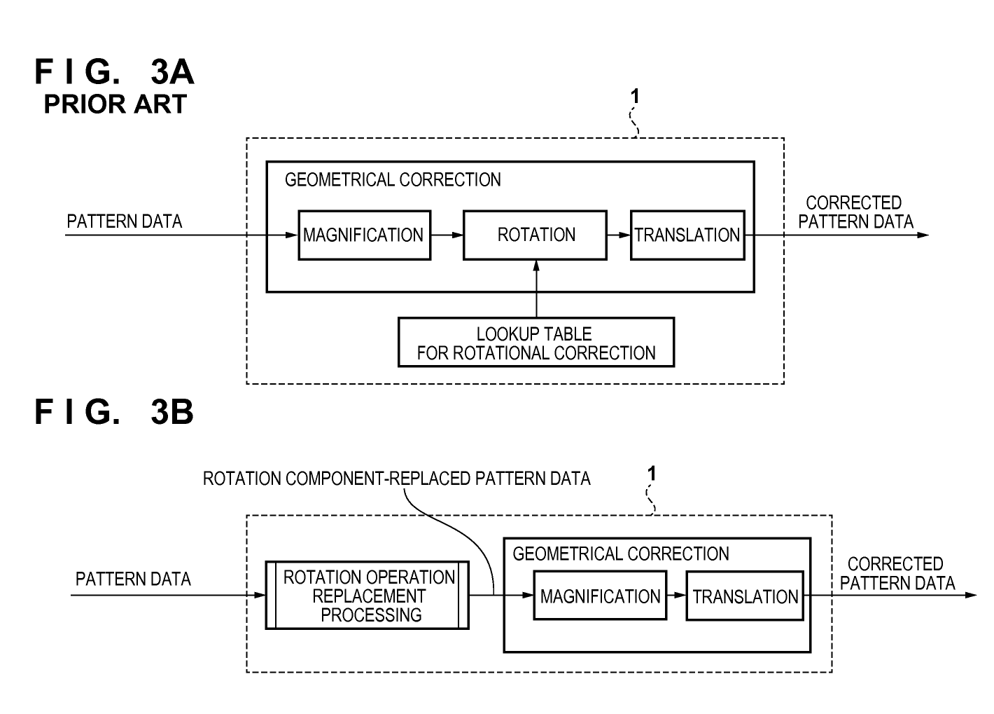

Pattern data correction processing in a drawing data generation method according to the first embodiment will be described with reference to FIGS. 3A and 3B. FIG. 3A is a block diagram showing the contents of processing by a processing apparatus 1 which performs correction processing in the related art. The conventional processing apparatus 1 receives pattern data (original data) as intermediate data obtained from design pattern data, performs geometrical correction for the original data, and outputs the corrected data (drawing data). The geometrical correction to be performed by the processing apparatus 1 includes correction of a change of the magnification, rotation, and shift of a pattern as basic linear correction. When the processing apparatus 1 uses a calculator such as a DSP for rotational correction, the approximation polynomial of a trigonometric function is used. When higher-speed online processing is requested of the processing apparatus 1, a combinational circuit such as an FPGA is used for rotational correction. Then, rotational correction is performed by looking up a lookup table (LUT) for a trigonometric function prepared in advance in a memory, instead of rotational correction by an approximation polynomial. FIG. 3A shows a method of looking up the lookup table. The processing apparatus 1 includes a lookup table for rotational correction. The size of this lookup table is determined by a requested accuracy.

FIG. 3B is a block diagram showing a processing apparatus 1 which performs correction processing according to the first embodiment. The processing apparatus 1 receives the same pattern data as that in FIG. 3A. The processing apparatus 1 obtains rotation component-replaced pattern data through processing of replacing an amount of rotation by the drawing apparatus among the input data into a translation amount (shift amount). As a result, the processing apparatus 1 omits a rotation operation in subsequent geometrical correction and substitutes a shift operation for equivalent processing. Hence, a heavy-load operation using an approximation polynomial and a rotation operation in which an operation using a large-size LUT is performed can be omitted, speeding up geometrical correction processing.

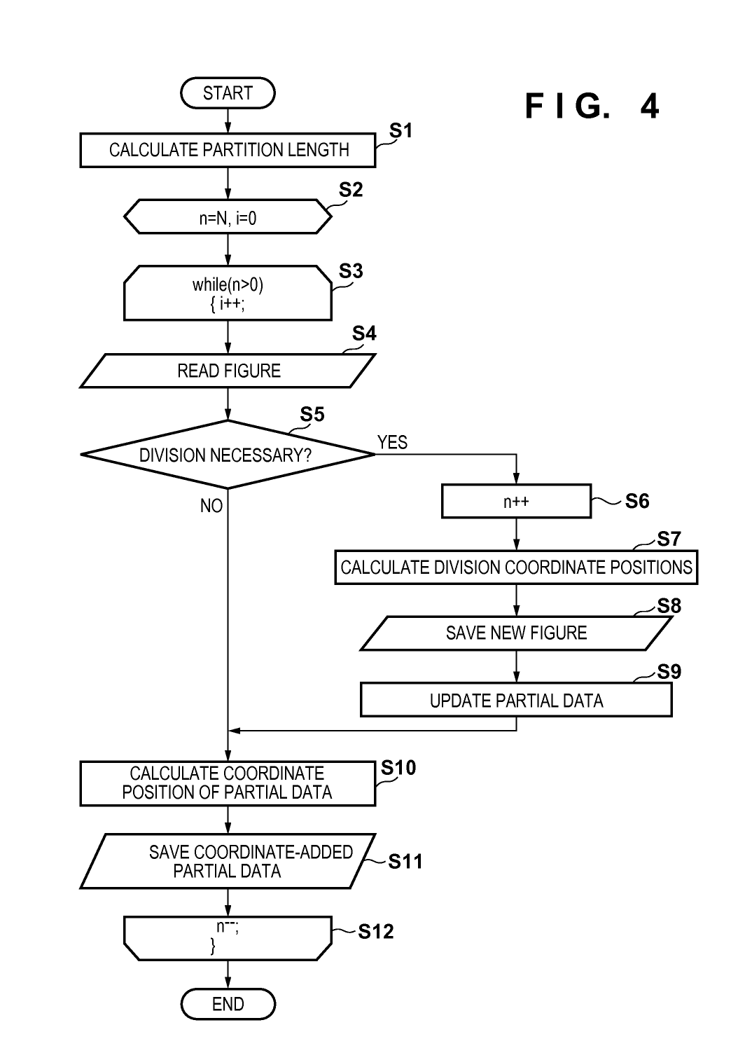

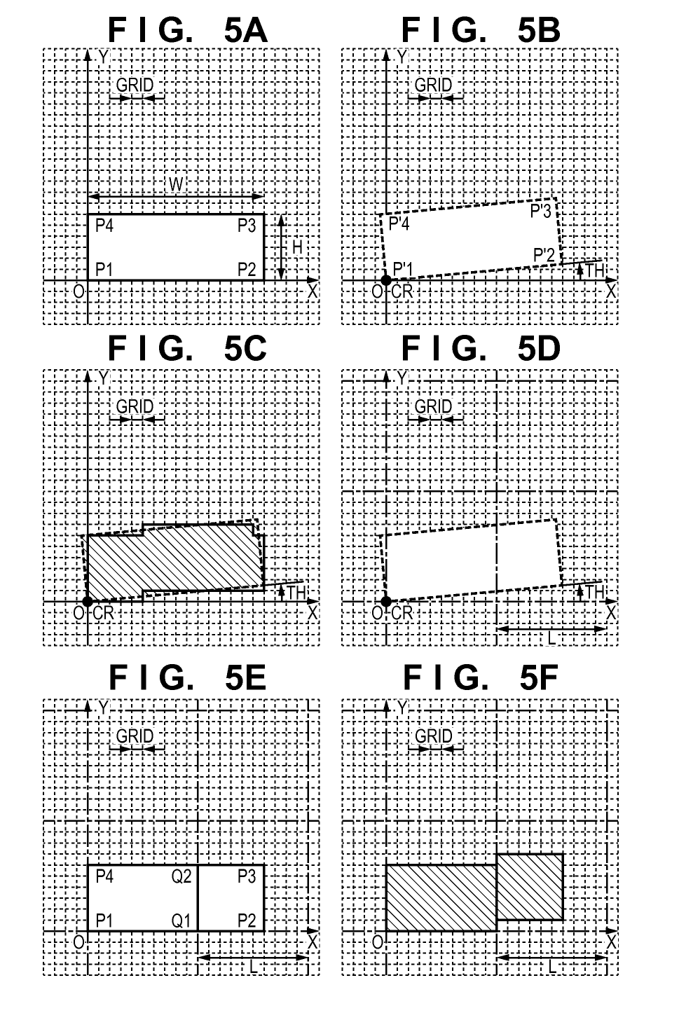

Rotation operation replacement processing shown in FIG. 3B will be explained with reference to the flowchart of FIG. 4 and the schematic views of FIGS. 5A to 5F showing the course of processes. Pattern data input for rotation operation replacement processing include various graphic data as created by CAD and the like. Assume that input pattern data is a simple rectangular pattern indicated by a solid line in FIG. 5A. The input pattern data is represented as a set of dots arranged in accordance with two-dimensional grids on a two-dimensional plane. Here, the two coordinate axes of the two-dimensional plane are defined as the X- and Y-axes. The data structure of the rectangular pattern is represented by vertex coordinate positions P1 to P4 or the coordinate position (typical coordinate position) P1 of a typical point which typifies a rectangle, a width W, and a height H. An angle TH representing the rotation amount of a pattern is obtained in advance separately from the measurement result of test exposure or the like. If the rotational correction operation is performed by the rotation angle TH, the pattern data after rotational correction becomes pattern data as indicated by a broken line in FIG. 5B. In an operation for rotation, let P(x, y) be the coordinate position of each vertex before rotation, and P′(x′, y′) be the coordinate position of each vertex after rotation. Then, x′ and y′ are represented by the following equations (1):

x′=x cos(TH)−y sin(TH)

y′=x sin(TH)+y cos(TH) (1)

When a LUT is used for calculation of a trigonometric function, a LUT which summarizes the correspondence between the rotation angle TH and the sin and cos values is prepared separately. The calculation of equations (1) is performed by sequentially searching the LUT for the cos(TH) and sin(TH) values and replacing them with the detected values by the processing apparatus 1. The conventional processing apparatus 1 obtains a pattern surrounded by a solid line in FIG. 5C by accurately representing rotation and then discretizing the coordinates of the pattern data by each grid.

To the contrary, the processing apparatus 1 according to the first embodiment of the present invention calculates a division length L first in step S1 prior to correction processing. The division length L is an interval (grid size) between adjacent straight lines among two straight line groups which are parallel to the X- and Y-axes, respectively, and divide two-dimensional grids into rectangular regions of the same size. The division length L is determined so that an amount obtained by multiplying the division length L and the rotation angle TH becomes, for example, one grid size. The amount obtained by multiplying the division length L and the rotation angle TH may be an integer multiple of the grid size, or may be the LSB (Least Significant Bit) as long as the data accuracy can be maintained in the course of processing. As the division length L, the grid unit, an integer multiple of it, or a value rounded at the LSB is used for discretization. For example, when the result of equations (2) is “7.1”, the value rounded at the LSB is “7” obtained by rounding the decimal part.

In the first embodiment, the division length L is a size corresponding to an integer multiple of grids, as shown in FIG. 5D. The rotation angle TH is a rotation component for correcting an axis shift of the electron optical system, a machine difference among the apparatuses, and alignment with the pattern of the underlayer of a wafer (substrate). The rotation angle TH is obtained from a simulation or the measurement result of an actually drawn test pattern. For this reason, the rotation angle TH is not limited to one value, and different values may be used for respective regions or the partial average of them may be used.

The rotation angle TH is not limited to these values, and the design allowance of the apparatus may be substituted. Note that the first embodiment will describe that the rotation angle TH takes one value. After the end of calculating the division length L, the processing apparatus 1 divides each pattern (partial pattern) included in the pattern data by the determined division length L, and acquires partial data of each rectangular region based on the division length L. In step S2, the processing apparatus 1 sets the number N of patterns (figures) included in the pattern data in an unprocessed figure counter n. In step S3, a loop of figure division processing (first processing) starts. This loop is circulated until n=0, that is, all figures are processed. Since there is one figure in the schematic views of FIGS. 5A to 5F, N=1.

In the loop, the processing apparatus 1 first reads one figure from the pattern data (step S4). At this time, attention is paid to a grid in which the feature point P1 of the read figure exists. In step S5, the processing apparatus 1 determines whether the read figure falls within a rectangular region defined by the division length in the division determination of the next step. In FIG. 5D, the rectangular region defined by the division length L is indicated by a chain line, and the figure lies across a plurality of (two) rectangular regions.

If the processing apparatus 1 determines in the division determination of step S5 that the figure lies across two or more rectangular regions, it determines that division processing is necessary for the figure, and performs the following processing. In step S6, the processing apparatus 1 increments the unprocessed figure counter n by one, and notifies that the number of figures to be processed increases as a result of the division processing. Then, in step S7, the processing apparatus 1 obtains intersection points (division coordinate position Q) between the figure and rectangular regions generated when the figure is divided into rectangular regions by the division length L. At this time, it suffices to obtain division coordinate position for only a rectangular region of interest. For a figure lying across two or more rectangular regions, division coordinate positions are sequentially calculated after dividing the figure. After obtaining the division coordinate positions, the processing apparatus 1 saves a figure Q1-P2-P3-Q2 outside the rectangular region of interest as a new figure in the pattern data in step S8. Subsequently, in step S9, the processing apparatus 1 updates the figure in the rectangular region of interest to be a figure P1-Q1-Q2-P4 fitting in the rectangular region by using the division coordinate positions. The division processing then ends.

In step S10, as for a figure to be processed, the processing apparatus 1 calculates the typical coordinate position D of the figure for which a shift amount along each coordinate axis is determined to correct a rotation angle (second processing). The typical coordinate position of partial data is obtained by normalizing original coordinate values by the division length L. The typical coordinate position of the figure P1-Q1-Q2-P4 is (0, 0), and that of the figure Q1-P2-P3-Q2 is (1, 0). More specifically, the typical coordinate position of each figure is determined using the coordinate values of a feature point nearest the origin or rotation center, or the barycentric coordinate values of a feature point. In step S11, the processing apparatus 1 calculates the typical coordinate position of the figure, adds the information to the figure of the partial data, and saves it. That is, figure data to be stored in the pattern data has information of the figure and coordinate information of the feature point. After the end of processing all figures, the loop ends (step S12), and the rotation operation replacement processing ends. The resultant output is rotation component-replaced pattern data obtained by adding coordinate information to original pattern data.

Referring back to FIG. 3B, geometrical correction processing will be explained. When the rotation component-replaced pattern data is input, the processing apparatus 1 performs magnification and shift correction operations for the rotation component-replaced data. Letting M(Mx, My) be the magnification correction amount, P(x, y) be the coordinate position of a vertex before the operation, and P′(x′, y′) be the coordinate position of the vertex after the operation, the coordinates x′ and y′ of the vertex after the magnification correction operation are calculated according to equations (2):

x′=Mx×x

y′=My×y (2)

Similarly, as for the shift correction operation, letting S(Sx, Sy) be the shift amount, the coordinates x′ and y′ of the vertex after the shift correction operation are calculated according to equations (3) using the shift amounts Sx and Sy:

x′=x+Sx

y′=y+Sy (3)

In the first embodiment in which pattern data has coordinate information, the rotation of a pattern is replaced with a shift in the following way. By using the typical coordinate position D(Dx, Dy) of the partial pattern, the rotation angle TH, and the division length L, the processing apparatus 1 obtains shift amounts SR(SRx, SRy) for correcting a rotation amount, according to equations (4):

SRx=−L×TH×Dy

SRy=L×TH×Dx (4)

The obtained shift amounts SR for correcting a rotation amount can be processed at the same time as an existing shift. Thus, the processing apparatus 1 according to the first embodiment uses equations (5) instead of equations (3) for the shift operation:

x′=x+Sx+SRx

y′=y+Sy+SRy (5)

When only rotational correction is applied without magnification correction or shift, a pattern indicated by hatching in FIG. 5F is obtained as a result of the series of processes. In the first embodiment, a value common to the two axes of the coordinate system is defined in determination of a division length and division of a figure. However, different values may be defined for the respective axes. When the division lengths L in the X and Y directions are set to different values, a resolution optimal for the type (shape or density) of pattern data can be obtained, and the processing efficiency and calculation accuracy can be balanced. The size at which a figure is divided may be changed for each region. It is significant to define a division length in accordance with the density of a pattern, or switch a division length for each portion so that distortion of the optical system can be corrected.

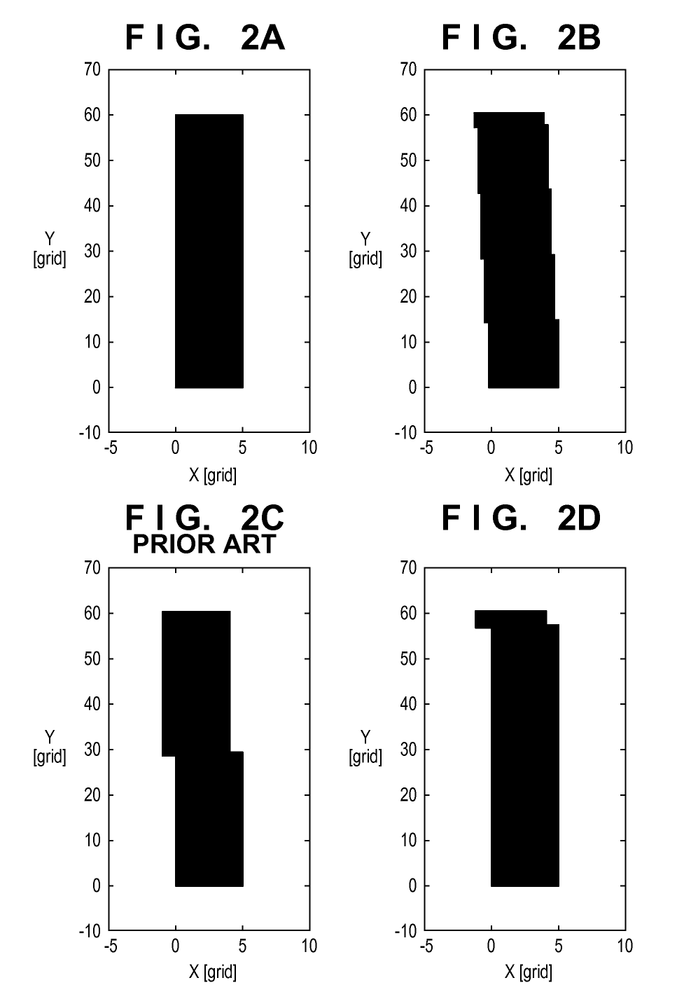

A calculation result when the above-described correction processing according to the first embodiment is executed will be compared with that of the conventional method by referring again to FIGS. 2A to 2D. The following are results of comparing, based on the area ratio, the errors of respective figures corrected by processing according to the conventional method in FIG. 2C and processing according to the method of the first embodiment in FIG. 2D with respect to a figure in FIG. 2B obtained by rotating an original figure in FIG. 2A:

error when no processing is performed: ((a)−(b))/(b)=0.216

error when processing according to the conventional method is performed: ((c)−(b))/(b)=0.103

error when processing according to the first embodiment is performed: ((d)−(b))/(b)=0.196

These results reveal that an error remaining after the processing according to the first embodiment is larger than an error remaining after the processing according to the conventional method, but the error is reduced in comparison with the case in which no correction processing is performed. Note that the example of FIG. 2D merely explains the present invention, and the size of a figure with respect to grids and the rotational correction amount are greatly different from actual ones. An actual rotational correction amount is very small and does not reflect the rotation operation in most cases. In this regard, the correction processing according to the first embodiment that achieves reduction of an error can reduce an error while improving the processing efficiency.

### Second Embodiment

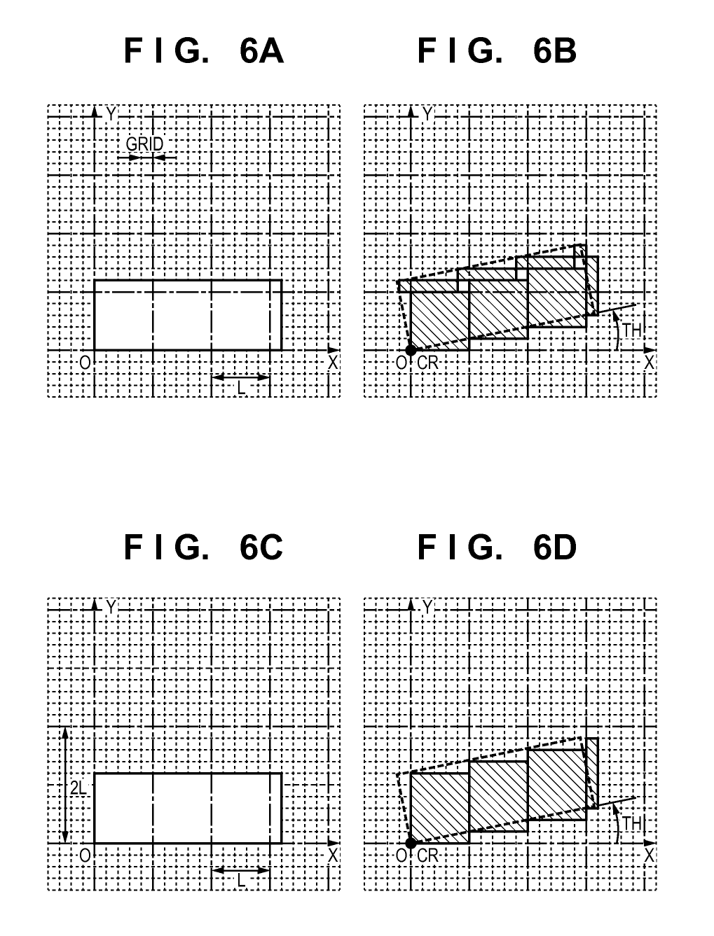

Correction processing according to the second embodiment will be explained with reference to FIGS. 6A to 6D. In this processing, the number of times of division processing is suppressed and the processing efficiency is improved by performing division processing at a division ratio suited to each coordinate axis in consideration of the dimensional ratio of pattern data or a drawing region. In the second embodiment, pattern data to undergo correction processing is assumed to be pattern data of a rectangle which is long along the X-axis, as shown in 6A. The division length L is determined by the rotation correction amount TH. If division lengths along the X- and Y-axes are equal to each other, as in the first embodiment, this pattern data is divided into four figures along the X-axis and two figures along the Y-axis, that is, a total of eight figures, as shown in FIG. 6B.

In the second embodiment, in step S7 in the flowchart shown in FIG. 4, a processing apparatus 1 calculates division coordinate positions while changing the division length used for each axis. More specifically, as shown in FIG. 6C, the division length along the Y-axis is set to be double the division length in the first embodiment (FIG. 6A). Then, the pattern data having undergone correction processing is not divided along the Y-axis, so the number of figures decreases to four, as shown in FIG. 6D. The residual errors, from accurate correction results indicated by chain lines in FIGS. 6B and 6D, of pattern data after correction processing according to the first embodiment that is indicated by a solid line in FIG. 6B, and pattern data after correction processing according to the second embodiment that is indicated by a solid line in FIG. 6D are compared. This comparison result indicates that these residual errors are not so different. Hence, when the dimensional ratio of pattern data is high, the division length is set for each axis. This can reduce the scale of division processing and improve the processing efficiency. Although the division lengths along the respective axes are L and 2L in the second embodiment, the ratio of them can be arbitrarily set to a positive-integer ratio.

### Third Embodiment

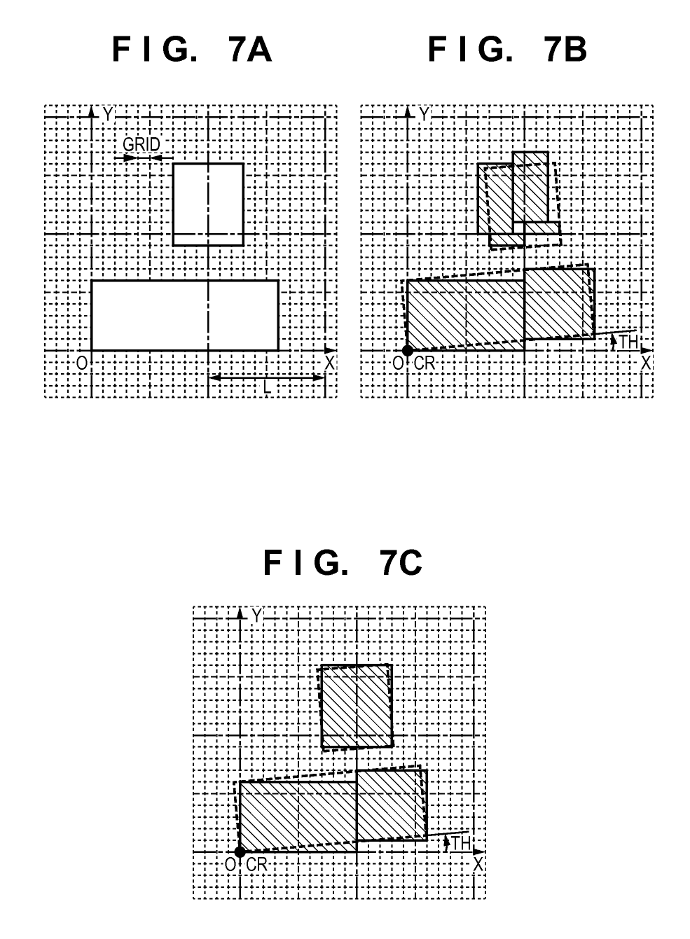

Correction processing according to the third embodiment that improves the processing efficiency by excluding division processing for a partial pattern having a substantially less action will be described with reference to FIGS. 7A to 7C. In the third embodiment, pattern data before correction includes a first portion formed from a large figure having a side longer than a division length, and a second portion formed from a small figure having a side shorter than the division length, as shown in FIG. 7A. Pattern data obtained after performing correction processing for both the first and second portions of this pattern data is pattern data indicated by hatching surrounded by solid lines in FIG. 7B.

In contrast, pattern data obtained after performing division processing for only the first portion formed from the large figure without performing division processing for the second portion formed from the small figure is indicated by hatching surrounded by solid lines in FIG. 7C. That is, in the third embodiment, a processing unit determines in division determination step S5 of FIG. 4 that the second portion need not be divided, and the process jumps to step S10 of calculating the coordinate position of partial data. More specifically, a setting condition to determine that division is necessary if the length of a side is larger than a division length can be added to the determination condition in division determination of step S5. In step S10 of calculating the coordinate position of partial data, a processing apparatus 1 regards the second portion formed from the small figure as one pattern data, and calculates a coordinate position to which a feature point nearest a rotation center CR belongs. In this case, the coordinate position is D(0, 0).

The residual errors, from accurate correction results indicated by chain lines in FIGS. 7B and 7C, of pattern data after correction processing according to the first embodiment that is indicated by a solid line in FIG. 7B, and pattern data after correction processing according to the third embodiment that is indicated by a solid line in FIG. 7C are compared. Apparently, the residual error in FIG. 7C is smaller. When, therefore, the size of pattern data is smaller than a division length, division processing is omitted, and both improvement of the processing efficiency and reduction of an error can be achieved. Although the division length L is used as a division determination condition in the third embodiment, a division length of a different ratio may be used for each axis, as described in the second embodiment.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium (which may also be referred to more fully as a ‘non-transitory computer-readable storage medium’). In such a case, the system or apparatus, and the recording medium where the program is stored, are included as being within the scope of the present invention.

The present invention is applicable as a method of creating, from design pattern data of a semiconductor integrated circuit such as an LSI, drawing data which can be input in a charged particle beam drawing apparatus. The present invention is also available in a lithography apparatus such as an ultrashort ultraviolet exposure apparatus, X-ray exposure apparatus, or multi-electron beam drawing apparatus.

[Article Manufacturing Method]

An article manufacturing method according to an embodiment of the present invention is suitable for manufacturing a microdevice such as a semiconductor device, and an article such as an element having a microstructure. This manufacturing method can include a step of forming a latent image pattern on a photosensitive agent applied to a substrate by using the aforementioned lithography apparatus (step of forming a pattern on a substrate), and a step of developing the substrate on which the latent image pattern is formed in the preceding step. Further, the manufacturing method can include other well-known steps (for example, oxidization, deposition, vapor deposition, doping, planarization, etching, resist removal, dicing, bonding, and packaging). The article manufacturing method according to the embodiment is superior to a conventional method in at least one of the performance, quality, productivity, and production cost of an article.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-009616, filed Jan. 22, 2013, which is hereby incorporated by reference herein in its entirety.

1. A generation method of generating drawing data for performing drawing on a substrate by a drawing apparatus based on pattern data associated with a two-dimensional grid, the method comprising steps of:
dividing the two-dimensional grid into a plurality of rectangular regions based on an angle by which the pattern data is rotated; and
obtaining a translation amount of partial data of the pattern data with respect to each of the plurality of rectangular regions based on the angle.

2. The method according to claim 1, wherein the dividing step performs the dividing based on the angle and a unit size of the two-dimensional grid.

3. The method according to claim 1, wherein letting L be a size of each of the plurality of rectangular regions, TH be the angle, and Dx and Dy be representative coordinates of the partial data normalized by L, each of SRx and SRy be the translation amount, the obtaining step obtains the translation amount based on equations:
SRx=−L×TH×Dy, and
SRy=L×TH×Dx.

4. The method according to claim 1, wherein two adjacent sides of each of the plurality of rectangular regions have respective lengths different from each other.

5. The method according to claim 4, wherein a size of each of the plurality of rectangular regions is determined based on a size of a pattern represented by the pattern data.

6. The method according to claim 1, wherein if a pattern represented by the pattern data is smaller than a size of one of the plurality of rectangular regions and extends into at least two of the plurality of rectangular regions, the translation amount is not obtained for the partial data corresponding to the pattern.

7. A processing apparatus for processing pattern data associated with a two-dimensional grid to generate drawing data for performing drawing on a substrate, the apparatus is configured to execute:
first processing of dividing the two-dimensional grid into a plurality of rectangular regions based on an angle by which the pattern data is rotated; and
second processing of obtaining a translation amount of partial data of the pattern data with respect to each of the plurality of rectangular regions based on the angle.

8. A storage medium storing a program for causing a computer to execute a generation method of generating drawing data for performing drawing on a substrate by a drawing apparatus based on pattern data associated with a two-dimensional grid, the method comprising steps of:
dividing the two-dimensional grid into a plurality of rectangular regions based on an angle by which the pattern data is rotated; and
obtaining a translation amount of partial data of the pattern data with respect to each of the plurality of rectangular regions based on the angle.

9. A drawing apparatus for performing drawing on a substrate with a charged particle beam based on drawing data, the apparatus comprising a processing apparatus for processing pattern data associated with a two-dimensional grid to generate the drawing data; wherein the processing apparatus is configured to execute:
first processing of dividing the two-dimensional grid into a plurality of rectangular regions based on an angle by which the pattern data is rotated; and
second processing of obtaining a translation amount of partial data of the pattern data with respect to each of the plurality of rectangular regions based on the angle.

10. A method of manufacturing an article, the method comprising steps of:
performing drawing on a substrate using a drawing apparatus;
developing the substrate having undergone the drawing; and
processing the developed substrate to manufacture the article,
the drawing apparatus performing drawing on the substrate with a charged particle beam based on drawing data, the apparatus including:
a processing apparatus configured to process pattern data associated with a two-dimensional grid to generate the drawing data,
wherein the processing apparatus is configured to execute:
first processing of dividing the two-dimensional grid into a plurality of rectangular regions based on an angle by which the pattern data is rotated; and
second processing of obtaining a translation amount of partial data of the pattern data with respect to each of the plurality of rectangular regions based on the angle.
